(19) United States
(12) Patent Application Publication
(10) Pub. No.: US 2024/0153250 A1
(43) Pub. Date: May 9, 2024

(54) NEURAL SHAPE MACHINE LEARNING FOR OBJECT LOCALIZATION WITH MIXED TRAINING DOMAINS

(71) Applicant: NEC Laboratories America, Inc., Princeton, NJ (US)

(72) Inventors: Bingbing Zhuang, San Jose, CA (US); Samuel Schulter, Long Island City, NY (US); Buyu Liu, Cupertino, CA (US); Zhixiang Min, Sunnyvale, CA (US)

(21) Appl. No.: 18/499,649

(22) Filed: Nov. 1, 2023

Related U.S. Application Data
(60) Provisional application No. 63/463,356, filed on May 2, 2023.
(60) Provisional application No. 63/421,607, filed on Nov. 2, 2022.

(51) Int. Cl. G06V 10/774; G06T 7/60; G06T 7/70; G06V 10/82; G06V 20/58

(52) U.S. Cl. CPC G06V 10/774; G06T 7/60; G06T 7/70; G06V 10/82; G06V 20/58; G06T 2207/20081; G06T 2207/20084; G06T 2207/30261

(57) ABSTRACT

Methods and systems for training a model include training a size estimation model to generate an estimated object size using a training dataset with differing levels of annotation. Two-dimensional object detection is performed on a training image to identify an object. The training image is cropped around the object. A category-level shape reconstruction is generated using a neural radiance field model. A normalized coordinate model is trained using the training image and ground truth information from the category-level shape reconstruction.

### RELATED APPLICATION INFORMATION

This application claims priority to U.S. Patent Application No. 63/421,607, filed on Nov. 2, 2022, and to U.S. Patent Application No. 63/463,356, filed on May 2, 2023, each incorporated herein by reference in its entirety. This application is related to an application entitled “SHAPE CONSTRUCTION-BASED MACHINE LEARNING MODEL FOR OBJECT LOCALIZATION,” having attorney docket number 22049, and which is incorporated by reference herein in its entirety.

### BACKGROUND

### Technical Field

The present invention relates to computer vision and, more particularly, to object localization in a three-dimensional environment.

### Description of the Related Art

Monocular cameras may be used for computer vision tasks, for example in helping an autonomous vehicle or robot navigate their environment. Because a monocular view lacks the depth perception that is inherent in binocular vision, such as in the human visual system, identifying the location of objects in three dimensional space can be challenging.

### SUMMARY

A method for training a model includes training a size estimation model to generate an estimated object size using a training dataset with differing levels of annotation. Two-dimensional object detection is performed on a training image to identify an object. The training image is cropped around the object. A category-level shape reconstruction is generated using a neural radiance field model. A normalized coordinate model is trained using the training image and ground truth information from the category-level shape reconstruction.

A system for training a model includes a hardware processor and a memory that stores a computer program. When executed by the hardware processor, the computer program causes the hardware processor to train a size estimation model to generate an estimated object size using a training dataset with differing levels of annotation, to perform two-dimensional object detection on a training image to identify an object, to crop the training image around the object, to generate a category-level shape reconstruction using a neural radiance field (NeRF) model, and to train a normalized coordinate model using the training image and ground truth information from the category-level shape reconstruction.

### BRIEF DESCRIPTION OF DRAWINGS

The disclosure will provide details in the following description of preferred embodiments with reference to the following figures wherein:

FIG. 1 is a diagram of an environment with different objects positioned around a camera in three-dimensional space, in accordance with an embodiment of the present invention;

FIG. 2 is a block diagram of a healthcare facility where three-dimensional object localization may be performed, in accordance with an embodiment of the present invention;

FIG. 3 is a block/flow diagram of a model for three-dimensional object localization that uses neural radiance field processing during training to supply ground truth information, in accordance with an embodiment of the present invention;

FIG. 4 is a block/flow diagram of a method of training and using a three-dimensional object localization model, in accordance with an embodiment of the present invention;

FIG. 5 is a block diagram of a computing device that can be used to train and implement a three-dimensional object localization model, in accordance with an embodiment of the present invention;

FIG. 6 is a diagram of a neural network architecture that may be used to form part of a three-dimensional object localization model, in accordance with an embodiment of the present invention; and

FIG. 7 is a diagram of a deep neural network architecture that may be used to form part of a three-dimensional object localization model, in accordance with an embodiment of the present invention.

### DETAILED DESCRIPTION OF PREFERRED EMBODIMENTS

Given an image from a single camera, the locations and orientations of objects within the image can be estimated. Additional information, such as its three-dimensional size, can also be determined. To that end, two-dimensional object detection may first be used to identify objects of interest within the image. The three-dimensional attributes of the objects can then be estimated. Three-dimensional object localization has applications in autonomous driving, advanced driver-assistance systems, traffic scene analysis, and healthcare.

A reconstruction-based approach to three-dimensional localization uses appearance information and is agnostic to camera geometry. This makes it possible to generalize across different data sources, with large variations in camera parameters and viewpoints. Because the ground truth for the shapes of objects may not be available, given the noisy nature of the data, a neural radiance field (NeRF) may be used to learn a category-level shape reconstruction. Three-dimensional pose annotations and instance masks in a training dataset may be used to learn the category level NeRF. While the category-level NeRF may translate an image of an object to its three-dimensional shape, it does not directly lend itself to localization. To this end, a deep neural network model may be trained to regress the normalized object coordinates. Ground truth values for the object coordinates may be rendered from the NeRF using a ground truth three-dimensional pose. The object coordinate representation gives correspondences between two-dimensional and three-dimensional representations. The three-dimensional pose may be estimated using perspective-n-point.

The NeRF learns category-level common knowledge by representing a shape as a linear combination of a set of low-rank NeRF bases. The coefficients of the linear combination may be learned by a convolutional neural network (CNN) conditioned on an input image. Because the shape reconstruction does not give a three-dimensional pose, and directly optimizing pose with differentiable rendering may be ambiguous, particularly in highly occluded cases, another CNN may be used to regress the normalized object coordinates from the input image of an object. Pixels of the image may be mapped to the normalized object coordinates with respect to the center of the object. The ground truth of the object coordinates during training may be obtained by rendering the learned category-level NeRF at the ground truth three-dimensional pose. Along with the estimated three-dimensional size, the two-dimensional to three-dimensional correspondences may be obtained from the normalized object coordinates.

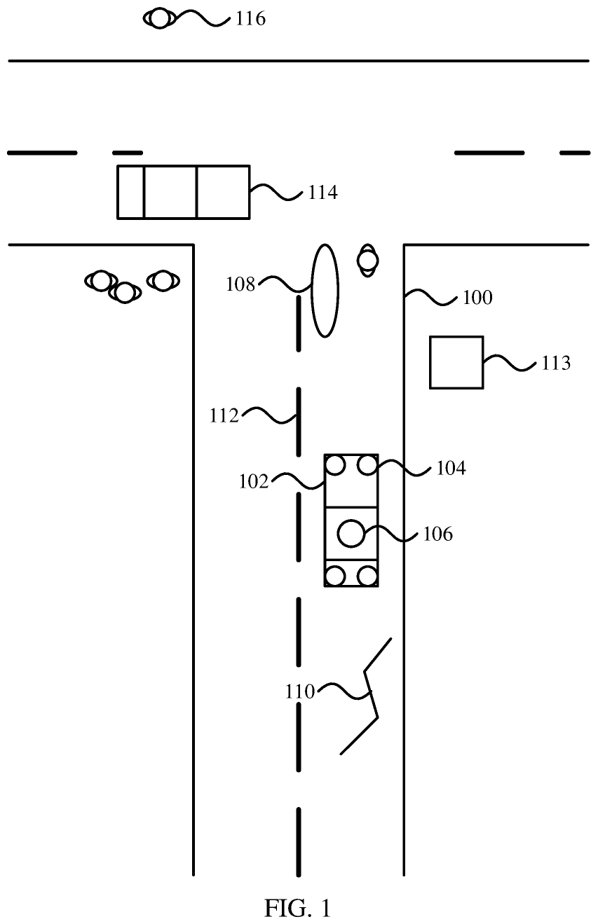

Referring now to FIG. 1, an exemplary road scene is shown. A vehicle 102 operates on a road 100. The vehicle 102 is equipped with sensors that collect information about the road 100. For example, the vehicle 102 may include several video cameras 104, positioned at different locations around the vehicle, to obtain visual information about the road 100 from multiple different perspectives and to provide a wide area of the scene. The vehicle 102 may further include a 360-degree LiDAR sensor 106, positioned to gather geometric information about the road 100 all around the vehicle 102.

The vehicle 102 records information from its sensors. The vehicle 102 may be used to collect information about the road 100 by driving across as many roadways in an area as possible. The information may be used to identify defects in the road 100 as well as objects in the surrounding environment. That information can be used to aid in navigation and control for the vehicle 102.

Exemplary defects include potholes 108, ruts, cracks 110, and fading in road markings 112. Exemplary objects include stationary objects 113 which may include traffic control features such barriers, as well as environmental control features such as streetlights and signage, and may further include stationary objects unrelated to the function of the road 100, such as mailboxes, newsstands, and trash cans. Mobile objects may include other vehicles 114 and pedestrians 116, which operate according to their own independent and unpredictable logic. The objects may therefore be interpreted as obstacles, which may present an immediate navigation challenge, or which may present a hazard or challenge in the future. Thus as a vehicle 102 navigates the road 100, its sensors collect information regarding the road itself and the stationary and mobile objects that it can see. The vehicle identifies a safe path and may autonomously navigate the environment to safely reach its destination.

In addition to the operation of an autonomous vehicle on a roadway, the present principles may be applied to any appropriate computer vision task where the identification and localization of objects in three-dimensional space is relevant. For example, a robot in a healthcare facility may have a function that involves navigating hallways to deliver supplies to healthcare professionals or to interact with patients. To accomplish such a task, the healthcare robot will need to navigate in a dynamic environment, where medical equipment is regularly moved and left in hallways and where medical professionals may need to urgently reach their destination. In such an environment, the robot may need to quickly identify and react to changes in its environment by locating objects in the three-dimensional space around it.

Although vehicle-mounted cameras 104 are specifically contemplated, both in collecting the training data and in using a trained object localization model, it should be understood that cameras may be mounted in other locations as well. For example, cameras may be mounted in fixed locations, for example on permanent or semi-permanent infrastructure. Data derived from such fixed sources may also be used in object localization, for example in the context of security monitoring to identify hazards and unauthorized personnel.

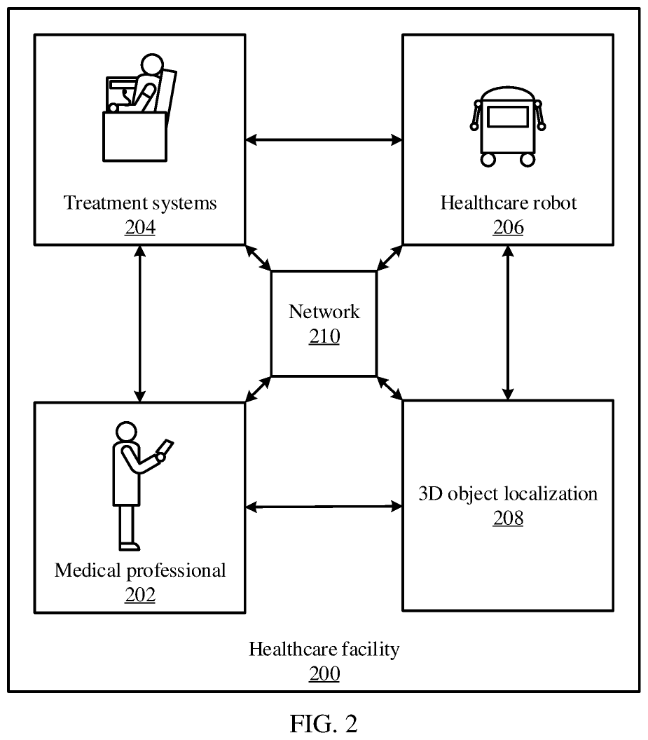

Referring now to FIG. 2, a diagram of object localization is shown in the context of a healthcare facility 200. A healthcare robot 206 may navigate through the environment of the healthcare facility 200. The robot 206 may provide assistance to medical professionals 202 may further interface with treatment systems 204 to help provide treatment to patients. The robot 206 may thereby be used to help monitor and treat multiple patients, for example responding to changes in environmental conditions and shortages of materials.

The healthcare facility may include one or more medical professionals 202 who provide information relating to events and measurements of system status. As they maneuver through the healthcare facility, the medical professionals 202 are both potential obstacles to the healthcare robot 206, as well as destinations relevant to the robot's task, as a robot 206 may be tasked with delivering supplies to a particular medical professional 202. Treatment systems 204 may represent stationary objects within the healthcare facility 200, which monitor patient status to generate medical records, and which may be designed to automatically administer and adjust treatments as needed.

The different elements of the healthcare facility 200 may communicate with one another via a network 210, for example using any appropriate wired or wireless communications protocol and medium. The healthcare robot 206 may thereby receive information relating to the positioning of other objects within the healthcare facility 200 using sensors that are located external to the robot itself.

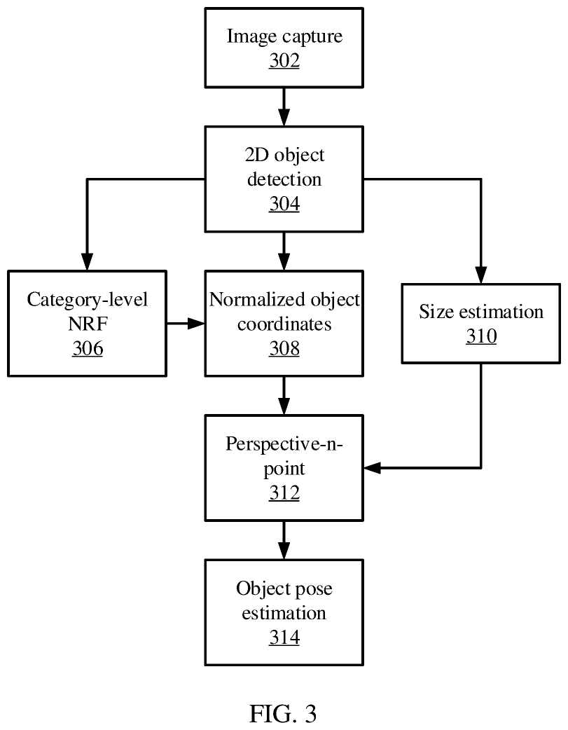

Referring now to FIG. 3, a block/flow diagram of a method/system for object localization in a three-dimensional space is shown. Block 302 captures a monocular image of the environment that includes at least one object. The captured image may include an array of red-green-blue (RGB) or grayscale pixels that indicate visual information. A backbone neural network model may be implemented as, e.g., a residual neural network (ResNet) to regress the normalized coordinate map and the object mask and to predict coefficients representing the shape and color of the objects. Two-dimensional object detection 304 is performed on the image to identify objects within the image. Any appropriate object detection model may be used, and the output of object detection may include two-dimensional bounding boxes for the detected objects, for example providing coordinates where the respective objects are located within the image.

Category-level NeRF 306 is performed for the detected objects. The image may be cropped within a corresponding bounding box for processing by a NeRF machine learning model that jointly optimizes a linear coefficient and a set of low-rank NeRF bases. The NeRF machine learning model may be implemented as, for example, a feature grid followed by a multilayer perceptron (MLP). The linear coefficient may be regressed by a CNN conditioned on the cropped image. Training of the NeRF, described in greater detail below, may be supervised by the instance mask and RGB value after differentiable rendering at the ground truth three-dimensional pose. Notably the NeRF 306 need only be performed during training, as it generates pseudo-ground truth labels for training other parts of the model.

A coordinate neural network model is used to regress the normalized object coordinates conditioned on the cropped input image in block 308, for example using a ResNet model. Training of the coordinate neural network model may be supervised by coordinates rendered from the category-level NeRF 306. During inference, the NeRF 306 may be omitted and the normalized coordinates may be determined based on the trained coordinate neural network model and the detected object information.

The size of the object is determined in block 310, for example using a machine learning model to regress the height, width, and length of the detected object. The size estimation may be performed using an appropriate convolutional neural network (CNN) model. Block 312 takes the normalized object coordinates and the estimated size and builds correspondences between two-dimensional and three-dimensional information. This perspective-n-point process may be implemented using linear algebra and a non-linear least squares optimization. Block 314 may then use the information gathered to estimate the post of the object in three dimensions.

Object localization aims to estimate the three-dimensional occupancy of an object as an enclosing three-dimensional box, parameterized by its dimension s=[l, h, w], where l is the object's length, h is the object's height, and w is the object's width as measured in any appropriate coordinate system. Localization further constructs a yaw angle θ and an object center point t=[x, y, z] in the coordinate system. A perspective-n-points problem is constructed from the cropped input image and the pose is solved therefrom.

For each pixel with normalized camera coordinates pᵢ=[uᵢ, vᵢ, 1]^{T}, a neural network model may be used to predict a corresponding object coordinate denoted as xᵢ=[xᵢ^{[x]}, xᵢ^{[y]}, xᵢ^{[z]}]. The object pose can then be solved by minimizing the reprojection error as:

$$arg {min}_{{R}_{θ} , t} {\sum }_{i} ρ ( {w}_{i} ( \frac{{R}_{θ} {x}_{i} + t}{{[ {R}_{θ} {x}_{i} + t ]}_{z}} ) )$$

where [⋅]_{z} denotes the z-axis component of the coordinate, R_{θ} is a rotation matrix form of the yaw-axis rotation θ, wᵢ is a confidence weight for each prediction, and ρ denotes an M-estimator using a Huber loss. In practice, object coordinates may be decoupled as normalized object coordinates oᵢ times a 3-vector size prediction s as xᵢ=sᵢ∘oᵢ for better instance scale and generalization to categorical variations.

For training the normalized objection coordinate prediction model, NeRF may be used with a localization branch. The image surrounding detected objects may be cropped out and used to regress the normalized coordinate map and object mask. The model additionally predicts two sets of coefficients representing the shape and color of the object instance used for deforming a NeRF-based shape model represented by latent grids. During training, ground truth object pose and size information is used to train the NeRF model with the object mask, appearance, and optionally LiDAR depth. The normalized coordinate prediction branch may then be supervised using normalized coordinates from the NeRF model. NeRF fuses categorical shape supervision from all training data to provide reliable and dense normalized coordinate supervision.

To benefit from accurate and dense normalized coordinate supervision, an image-conditioned shape representation (e.g., NeRF) is trained that fuses shape supervision from multiple sources to render dense normalized coordinate supervision for localization. Such sources may include object masks, LiDAR data, and depth maps. A three-dimensional latent grid ϕ may be used as a shape representation, implemented as a multi-resolution dense grid. For an input normalized object coordinate oᵢ, the grid may trilinearly interpolate nodes and stack the output from multiple resolutions to return a D-dimensional feature as output. The output may be decoded by a small MLP network to output density and RGB color. The terms Φ^{[c]}(o)=c∈ [symbol] ³ and Φ^{[σ]}(o)=σ∈ [symbol] ¹ may respectively denote extracting and decoding a normalized coordinate from the grid Φ into color and density separately. This shape representation need not model view-dependent effects.

To model categorical shape variation, a set of learnable 3D latent grids is used to compose a low-rank deformable shape representation. A mean shape grid ϕ_{μ} and a set of deformation grid bases {ϕᵢ|i=1 . . . B} may be defined, where B is the number of bases. Given each object, a B-dimensional coefficient z∈ [symbol] ^{B} is generated by the network. The Φ_{μ} may be deformed in latent space using a deforming basis and a new latent grid Φ_{obj} may be constructed as the deformed object as

$${Φ}_{obj} = {Φ}_{μ} + \frac{{\sum }_{i = 1}^{B} {z}_{i} {ϕ}_{i}}{B}$$

Because the deformation is applied in feature space, it can affect both shape and color in the decoded output. By limiting the number of bases, the deformation is forced to have a low-rank structure, with the number of bases being much smaller than the grid dimension. This forced object instances to explore categorical common shape structures by sharing deformation grids.

The grid is compatible with volume rendering. For each object, given a viewing ray

$${r}^{[ γ ]} = q + γ d ∘ \frac{1}{s}$$

in its normalized object coordinate system, where q is a camera center, d is a viewing direction, and γ is a distance along the ray, the color can be rendered as:

$$c ( r ) = {\int }_{{γ}_{n}}^{{γ}_{f}} α ( {r}^{[ γ ]} ) {Φ}^{[ σ ]} ( {r}^{[ γ ]} ) {Φ}^{[ c ]} ( {r}^{[ γ ]} ) d γ$$

$$α ( {r}^{[ γ ]} ) = {e}^{- {\int }_{{γ}_{n}}^{{γ}_{f}} {Φ}^{[ σ ]} ( {r}^{[ ζ ]} ) d ζ}$$

where Φ^{[c]}(⋅)∈ [symbol] ³ and Φ^{[σ]}(⋅)∈ [symbol] ¹ denote decoding the latent grid Φ at a given query point into color and density, respectively, and ζ is the distance to be integrated between γ and γₙ. The function c(⋅) i the ray color and α(r^{[γ]}) is the ray opacity. The occupancy map indicating the object mask is rendered by:

m(r)=∫_{γ}_{ₙ}^{γ}^{_{f}}α(r^{[γ]})Φ^{[σ]}(r^{[γ]})dγ

The normalized coordinate map can be rendered by directly integrating the normalized coordinates as:

$$o ( r ) = \frac{{\int }_{{γ}_{n}}^{{γ}_{f}} α ( {r}^{[ γ ]} ) {Φ}^{[ σ ]} ( {r}^{[ γ ]} ) {r}^{[ γ ]} d γ}{m ( r )}$$

The near and far distances γₙ and γ_{f} may be determined as the intersection of the ray with the object bounding box, so that only points within the bounding box are sampled.

The training of a shape representation may include multiple shape losses, including occupancy loss, RGB loss, and additional shape supervisions from LiDAR and dense depth maps:

[symbol]

ₛₕₐₚₑ= [symbol] _{occ}+ [symbol] _{rgb}+( [symbol] _{LiDAR}+ [symbol] _{depth})

where the LiDAR and depth map contributions are optional.

The occupancy loss may be supervised with ground-truth triplet mask that includes three categories: foreground, background, and unknown (e.g., occluded). The occupancy may be set to 1 at the foreground, 0 at the background, and may be omitted for unknowns. The other losses may be applied to the foreground regions. For [symbol] _{LiDAR} and [symbol] _{depth}, the depth may be converted with ground-truth object pose and size into normalized coordinates and points outside the normalized coordinate boundary may be discarded.

Although the RGB loss is not needed for learning shapes, having an auxiliary RGB loss provides additional photometric constraints that regularize the shape and improve performance. The shape and color bases and coefficients may be decoupled. For training the latent basis, high-quality examples (e.g., having a height of at least 40 pixels and no occlusions) may be used. Otherwise, the latent basis may be frozen and optimized for the coefficient predictions.

Despite the use of allow-rank space to enforce different object instances in their sharing of deformation bases, the deformation may not be well-regularized, resulting in unnecessary deformation countering each other and producing a noisy shape result. The mask supervision further has the visual hull ambiguity, and the sparse LiDAR information may not fully cover the object, leaving ambiguities for uncovered and unobserved regions. These imperfect shape supervisions may cause unpredictable random deformations.

To mitigate this risk, a Kullback-Leibler (KL) divergence loss may be used to minimize the information gain from the deformation coefficients:

[symbol]

_{KL}=KL(q(z|I)∥p(z))

where p(z)˜ [symbol] (0,1) is a latent coefficient distribution and I is the object image, and z is sampled from q(z|I) using reparameterization for optimization.

Under the absence of depth supervisions, the occupancy loss alone is conceptually a shape-from-silhouette reconstruction, which suffers ambiguity from the visual hull. To further regularize the shape randomness to the ambiguity, a dense shape prior may be used to favor solid over empty space if both are possible solutions:

$${ℒ}_{dense} = - \frac{{\sum }_{s}^{S} {e}^{- {Φ}^{[ σ ]} ( {o}_{s} ) \cdot d}}{S}$$

where oₛ is a randomly sampled normalized coordinate, d=0.05 is an exemplary hyperparameter of a virtual integral distance, and S=1024 is an exemplary number of samples per batch.

As noted above, global context for objects is omitted by cropping the images around detected objects. The global context that would otherwise be available from the full captured image may have a detrimental effect on learning normalized coordinates, leading to decreased performance for distant, small objects and for highly occluded objects. Removing context from the input forces the network to learn normalized coordinates by a strict mapping from object appearance to coordinates, and may therefore provide better generalization.

The identification of normalized coordinates may therefore be decoupled from the task of object detection, using separate machine learning models to perform each. For the normalized coordinates, consistency between the model's coordinate prediction and the coordinate rendering may be enforced. With a predicted object latent coefficient z from the model, a latent shape representation Φ_{obj} may be obtained and a normalized coordinate map may be rendered using the ground-truth pose and size, following o*(r|Φ_{obj}).

The normalized coordinate consistency loss may be expressed as the L2 loss between the predicted coordinates and the rendered coordinates:

$${ℒ}_{noc} = \frac{{\sum }_{i ∈ {Ω}_{fg}} {‖ {o}_{i}^{[ pred ]} - {o}_{i}^{[ render ]} ‖}^{2}}{\vert {Ω}_{fg} \vert}$$

where Ω_{fg} denotes the foreground pixel set provided by the ground-truth mask. The coordinate prediction branch may be viewed as a student model that does not itself own shape information. However, enforcing bi-directional consistency optimizes NeRF as well, as it homogenizes the hard-to-learn high-frequency details in the latent shape grid, speeding up convergence.

Additionally, a self-supervised reprojection error loss may further be used, which amplifies the loss orthogonal to the viewing ray direction as

$${ℒ}_{reproj} = \frac{{\sum }_{i ∈ {Ω}_{fg}} {‖ {r}_{i}^{[ rep ]} ‖}^{2}}{\vert {Ω}_{fg} \vert} where$$

$${r}_{i}^{[ rep ]} = \frac{\hat{R} ( \hat{s} ∘ {o}_{i} ) + \hat{t}}{{[ \hat{R} ( \hat{s} ∘ {o}_{i} ) + \hat{t} ]}_{z}} - {p}_{i}$$

A per-pixel foreground probability wᵢ∈[0,1] may be learned from ground-truth foreground mask, to serve as weight in the perspective-n-points problem as

$${ℒ}_{fg} = \frac{{\sum }_{i ∈ {Ω}_{fg}} {( 1 - {w}_{i} )}^{2}}{\vert {Ω}_{fg} \vert} + \frac{{\sum }_{i ∈ {Ω}_{fg}^{c}} {( {w}_{i} )}^{2}}{\vert {Ω}_{fg}^{c} \vert}$$

where Ω_{fg}^{c} is the complement of Ω_{fg}. The foreground probability is used as a weight.

Given object size prediction from the detection branch and NOCs with uncertainties, the PnP problem may be solved using the Levenberg-Marquardt algorithm with a random sampling initialization scheme. To predict the confidence of pose, the 3D bounding box IoU may be regressed from the feature map. The network cannot imply the object distance from cropped object image due to the lack of context, which prevents the network from implying the pose uncertainty caused by object distance. The Jacobian map of reprojection error over the solved pose may be used as the input feature:

$$\frac{\partial {r}_{i}^{[ rep ]}}{\partial t} = [ \begin{matrix}\frac{\partial {[ {r}_{i}^{[ rep ]} ]}_{x}}{\partial {[ t ]}_{x}} & 0 & \frac{\partial {[ {r}_{i}^{[ rep ]} ]}_{x}}{\partial {[ t ]}_{z}} \\ 0 & \frac{\partial {[ {r}_{i}^{[ rep ]} ]}_{y}}{\partial {[ t ]}_{y}} & \frac{\partial {[ {r}_{i}^{[ rep ]} ]}_{y}}{\partial {[ t ]}_{x}} \\ 0 & 0 & 0\end{matrix} ]$$

where the non-zero elements may be flattened as a feature vector for each pixel. The Jacobian map indicates the derivative of object movements in image projection coordinates, where distance objects tend to have smaller derivatives. More generally, the Jacobian measures the stability and correlates with the uncertainty of the solved pose, thus supplying the network with informative signals to reason accuracy. The Jacobian map may be concatenated with the object feature map, normalized coordinates, and uncertainty predictions to regress the object score, making the prediction aware of current object distance and the pose estimation. The predicted intersection over union (IoU), which determines how well two bounding boxes overlap or align with one another, may be multiplied with the confidence score from the detector branch.

The scale of monocular localization is inherently an ill-posed problem, while perspective-n-points-based methods that solely rely on object size prediction could be unreliable. Hence, direct depth prediction may be fused with prediction-n-points. With a direct depth prediction d_{pred}, object size prediction s may be updated as:

$${s}^{′} = \frac{{d}_{pred} + {[ t ]}_{z}}{2 \cdot {[ t ]}_{z}} s$$

where t is the translation solved from prediction-n-points, and s′ averages the current size prediction with an optimal size that gives the prediction depth d_{pred} in the current prediction-n-points problem. To further maintain the optimality of the pose solution in the prediction-n-points problem, the translation estimation t as may be scaled as:

$${t}^{′} = \frac{{d}_{pred} + {[ t ]}_{z}}{2 \cdot {[ t ]}_{z}} t$$

Through this, the world scale is fused across object size prediction and direct depth prediction without affecting the optimality and reprojection error in the prediction-n-points problem.

Additional challenges are introduced in cross-domain object localization tasks. A domain gap can degrade performance due to scenes and sensor configurations. For example, if a localization model is trained on a first city, but is tested on a second city, the performance may drop due to the different distributions of scene structures in the two cities. Even within the same city, performance may drop if the sensor configuration is changed between the sensor that obtains the training data and the sensor that is used for inference. Such sensor configuration changes may include, for example, mounting positions, orientations, and camera intrinsic parameters.

Training an object localization system may involve the use of large amounts of training data with accurate annotations, made in the same domain as the test data. However, this significantly limits the scalability and flexibility of three dimensional object localization in real-world applications.

The normalized coordinate model may be trained with images from a first domain, with full three-dimensional box annotations. In the new domain, full annotations may not be available, so it cannot be assumed that object size can be estimated. The object size can be annotated and trained with a lower cost than the full annotations. Unlike the full annotations, the annotation of just object size can be achieved without needing LiDAR data. A size prediction network may then be adapted to the new domain using the more limited size annotations.

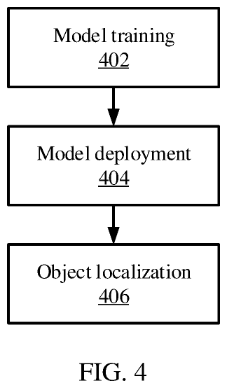

Referring now to FIG. 4, an overview of a method for training and using an object localization model is shown. Model training 402 uses an annotated training dataset to jointly train a category-level NeRF model and a regression network to predict normalized coordinates with foreground masks, for example using a deep learning approach. The NeRF is represented as trainable latent grids that include a canonical mean grid and several low-rank grid bases accounting for deformation. The bases are linearly combined by image-conditioned learnable coefficients. The NeRF-rendered normalized coordinates supervise the normalized coordinates' regression from images.

Training may include the training of the size estimation model. As noted above, size estimation may be based on training data from disparate domains, and the training data from the different domains may have different levels of annotation. Whereas some training data may have relatively complete annotation information, other training data may be annotated only with the size of objects in the images. Both sets may be used to train the size estimation model.

The change between domains may also include viewpoint changes. For example, training data that is captured by autonomous vehicles or robots may be used to train a model that is deployed to stationary, infrastructure-based systems, such as cameras fixed to a utility pole by a roadside or security cameras within a healthcare facility. During training, it can be assumed that the camera is calibrated with respect to a ground plane.

After training is complete, the trained model may be deployed 404. Such deployment may include copying the trained model parameters to a target vehicle or robot, so that the target may perform object localization 406. During inference, the NeRF rendering is not needed, while the normalized coordinate regression may be used by perspective-n-points for three-dimensional localization. Thus, deployment 404 may not copy the NeRF part of the model, as its output is no longer needed to act as pseudo ground truths for training.

During object localization 406, for images from infrastructure-mounted cameras, object detection may be performed and the detected objects may be handled by the normalized coordinate model. Given the per-pixel normalized coordinate prediction, an optimization objective may be formulated as a reprojection loss in the perspective-n-point problem, but both object size and object pose may be jointly optimized. The object location may be constrained to lie in the calibrated ground plane as a prior, removing the scale ambiguity in the single-view three-dimensional reconstruction and making it possible to optimize object size together with object pose.

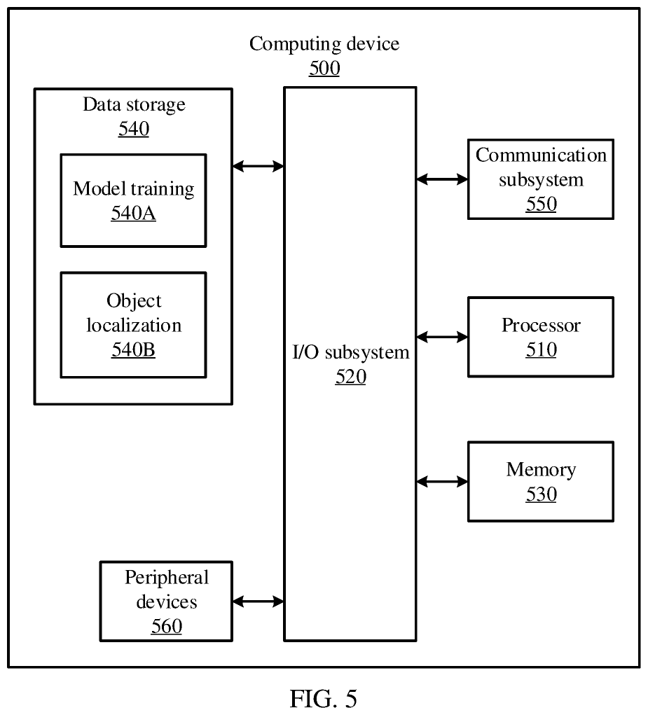

Referring now to FIG. 5, an exemplary computing device 500 is shown, in accordance with an embodiment of the present invention. The computing device 500 is configured to train and use an object localization model.

The computing device 500 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 500 may be embodied as one or more compute sleds, memory sleds, or other racks, sleds, computing chassis, or other components of a physically disaggregated computing device.

As shown in FIG. 5, the computing device 500 illustratively includes the processor 510, an input/output subsystem 520, a memory 530, a data storage device 540, and a communication subsystem 550, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 530, or portions thereof, may be incorporated in the processor 510 in some embodiments.

The processor 510 may be embodied as any type of processor capable of performing the functions described herein. The processor 510 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 530 may be embodied as any type of volatile or non-volatile memory or data storage capable of performing the functions described herein. In operation, the memory 530 may store various data and software used during operation of the computing device 500, such as operating systems, applications, programs, libraries, and drivers. The memory 530 is communicatively coupled to the processor 510 via the I/O subsystem 520, which may be embodied as circuitry and/or components to facilitate input/output operations with the processor 510, the memory 530, and other components of the computing device 500. For example, the I/O subsystem 520 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 520 may form a portion of a system-on-a-chip (SOC) and be incorporated, along with the processor 510, the memory 530, and other components of the computing device 500, on a single integrated circuit chip.

The data storage device 540 may be embodied as any type of device or devices configured for short-term or long-term storage of data such as, for example, memory devices and circuits, memory cards, hard disk drives, solid state drives, or other data storage devices. The data storage device 540 can store program code 540A for model training and 540B for three-dimensional object localization. Any or all of these program code blocks may be included in a given computing system. The communication subsystem 550 of the computing device 500 may be embodied as any network interface controller or other communication circuit, device, or collection thereof, capable of enabling communications between the computing device 500 and other remote devices over a network. The communication subsystem 550 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 500 may also include one or more peripheral devices 560. The peripheral devices 560 may include any number of additional input/output devices, interface devices, and/or other peripheral devices. For example, in some embodiments, the peripheral devices 560 may include a display, touch screen, graphics circuitry, keyboard, mouse, speaker system, microphone, network interface, and/or other input/output devices, interface devices, and/or peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 500 are readily contemplated by one of ordinary skill in the art given the teachings of the present invention provided herein.

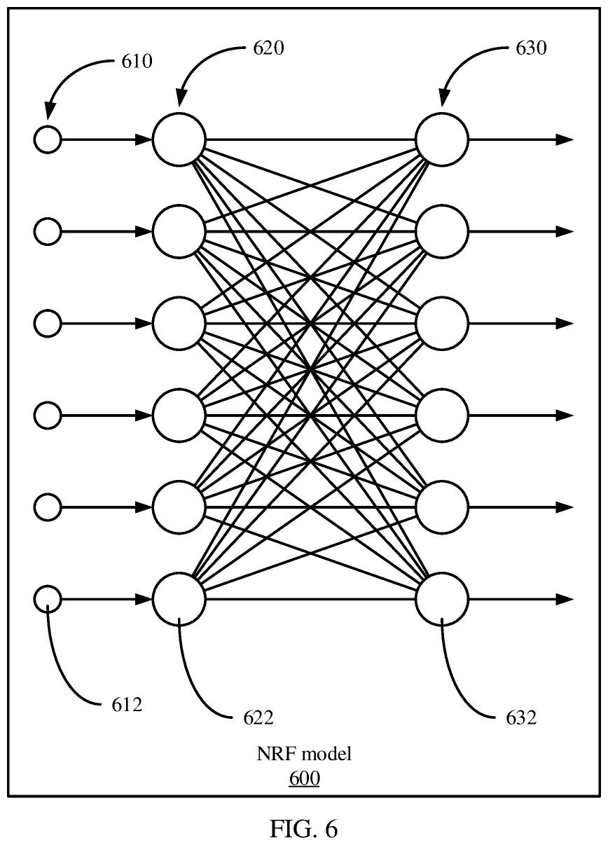

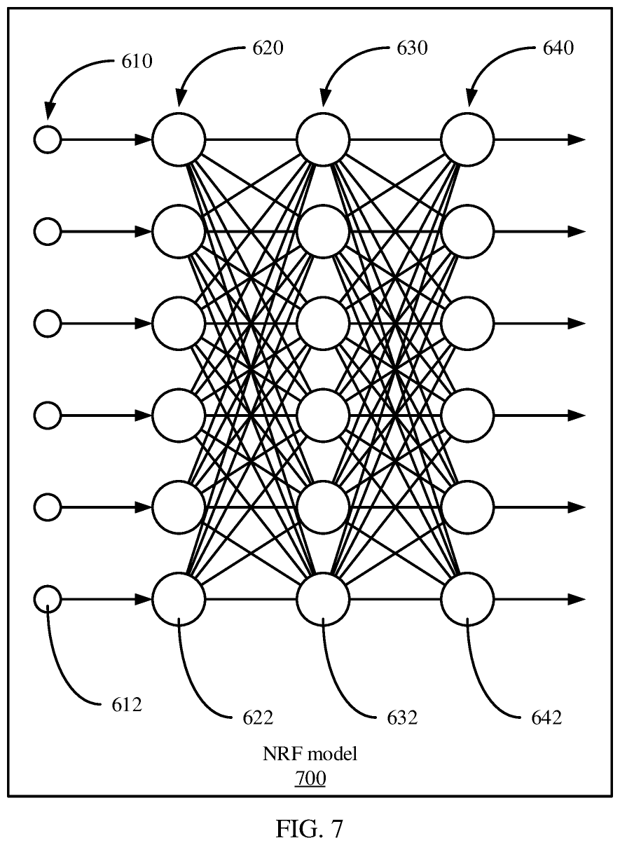

Referring now to FIGS. 6 and 7, exemplary neural network architectures are shown, which may be used to implement parts of the present models, such as NeRF models 602 and 702. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 620 of source nodes 622, and a single computation layer 630 having one or more computation nodes 632 that also act as output nodes, where there is a single computation node 632 for each possible category into which the input example could be classified. An input layer 620 can have a number of source nodes 622 equal to the number of data values 612 in the input data 610. The data values 612 in the input data 610 can be represented as a column vector. Each computation node 632 in the computation layer 630 generates a linear combination of weighted values from the input data 610 fed into input nodes 620, and applies a non-linear activation function that is differentiable to the sum. The exemplary simple neural network can perform classification on linearly separable examples (e.g., patterns).

A deep neural network, such as a multilayer perceptron, can have an input layer 620 of source nodes 622, one or more computation layer(s) 630 having one or more computation nodes 632, and an output layer 640, where there is a single output node 642 for each possible category into which the input example could be classified. An input layer 620 can have a number of source nodes 622 equal to the number of data values 612 in the input data 610. The computation nodes 632 in the computation layer(s) 630 can also be referred to as hidden layers, because they are between the source nodes 622 and output node(s) 642 and are not directly observed. Each node 632, 642 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 632 in the one or more computation (hidden) layer(s) 630 perform a nonlinear transformation on the input data 612 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training a model, comprising:
training a size estimation model to generate an estimated object size using a training dataset with differing levels of annotation;
performing two-dimensional object detection on a training image to identify an object;
cropping the training image around the object;
generating a category-level shape reconstruction using a neural radiance field (NeRF) model; and
training a normalized coordinate model using the training image and ground truth information from the category-level shape reconstruction.

2. The method of claim 1, wherein the training image is of a navigable environment in a healthcare facility and the object is a navigation obstacle.

3. The method of claim 1, wherein training the normal coordinate model includes training a neural network model using a deep learning process.

4. The method of claim 1, wherein training the coordinate model includes optimizing a loss function that includes an occupancy term, a color information term, a LiDAR term, and a depth term.

5. The method of claim 1, wherein training the training dataset is derived from multiple different domains having differing degrees of annotation.

6. The method of claim 5, wherein at least one domain of the training dataset lacks location and orientation annotation, but has object size annotation.

7. The method of claim 5, wherein the multiple different domains reflect differences in sensor configuration and/or location.

8. The method of claim 1, wherein cropping the image excludes information from the training image outside of a bounding box determined by the object detection.

9. The method of claim 1, further comprising determining a three-dimensional pose of the object based on normalized coordinates from the normalized coordinate model and the estimated object size.

10. The method of claim 9, further comprising using the normalized coordinates and the three-dimensional pose of the object in an autonomous vehicle to navigate through an environment.

11. A system for training a model, comprising:
a hardware processor; and
a memory that stores a computer program which, when executed by the hardware processor, causes the hardware processor to:
train a size estimation model to generate an estimated object size using a training dataset with differing levels of annotation;
perform two-dimensional object detection on a training image to identify an object;
crop the training image around the object;
generate a category-level shape reconstruction using a neural radiance field (NeRF) model; and
train a normalized coordinate model using the training image and ground truth information from the category-level shape reconstruction.

12. The system of claim 11, wherein the training image is of a navigable environment in a healthcare facility and the object is a navigation obstacle.

13. The system of claim 11, wherein the computer program further causes the hardware processor to train neural network model using a deep learning process.

14. The system of claim 11, wherein the computer program further causes the hardware processor to optimize a loss function that includes an occupancy term, a color information term, a LiDAR term, and a depth term.

15. The system of claim 11, wherein the training dataset is derived from multiple different domains having differing degrees of annotation.

16. The system of claim 15, wherein at least one domain of the training dataset lacks location and orientation annotation, but has object size annotation.

17. The system of claim 15, wherein multiple different domains reflect differences in sensor configuration and/or location.

18. The system of claim 11, wherein the computer program further causes the hardware processor to crop the image to exclude information from the training image outside of a bounding box determined by the object detection.

19. The system of claim 11, wherein the computer program further causes the hardware processor to determine a three-dimensional pose of the object based on normalized coordinates from the normalized coordinate model and the estimated object size.

20. The system of claim 19, wherein the computer program further causes the hardware processor to use the normalized coordinates and the three-dimensional pose of the object in an autonomous vehicle to navigate through an environment.
